(19) United States
(12) Patent Application Publication
(10) Pub. No.: US 2013/0162764 A1
(43) Pub. Date: Jun. 27, 2013

(54) IMAGE PROCESSING APPARATUS, IMAGE PROCESSING METHOD, AND NON-TRANSITORY COMPUTER-READABLE MEDIUM

(71) Applicant: FUJIFILM Corporation, Tokyo (JP)

(72) Inventor: Tomonori MASUDA, Saitama-shi (JP)

(73) Assignee: FUJIFILM CORPORATION, Tokyo (JP)

(21) Appl. No.: 13/767,500

(22) Filed: Feb. 14, 2013

Related U.S. Application Data
(63) Continuation of application No. PCT/JP2011/062895, filed on Jun. 6, 2011.

(30) Foreign Application Priority Data
Aug. 16, 2010 (JP) 2010-181815

(51) Int. Cl. H04N 13/00

(52) U.S. Cl. CPC H04N 13/0022
USPC 348/42

(57) ABSTRACT

An image processing apparatus comprising an image processing unit that applies, for left and right complement target areas serving as non-output areas respectively positioned closer to the center of the output plane than the left and right reference boundaries set by the reference boundary setting unit, image information about adjacent areas serving as partial areas within the left and right viewpoint images respectively adjacent to the left and right complement target areas, respectively, to the left and right complement target areas, to complement image information about the left and right complement target areas in each of the stereoscopic image frames and an output unit that outputs each of the stereoscopic image frames in which the image processing unit has complemented the image information to the left and right complement target areas according to the disparities adjusted by the disparity adjustment unit.

### CROSS-REFERENCE TO RELATED APPLICATIONS

This application is a continuation application and claims the priority benefit under 35 U.S.C. §120 of PCT Application No. PCT/JP2011/062895 filed on Jun. 6, 2011 which application designates the U.S., and also claims the priority benefit under 35 U.S.C. §119 of Japanese Patent Application No. 2010-181815 filed on Aug. 16, 2010, which applications are all hereby incorporated by reference in their entireties.

### TECHNICAL FIELD

The present invention relates to image processing, and more particularly, to processing for complementing an image after adjustment of a binocular disparity in each of stereoscopic image frames of a stereoscopic moving image.

### BACKGROUND ART

According to PTL 1, when a missing portion occurs at each of edges of a left-eye image and a right-eye image as a result of disparity adjustment by shifting a disparity image, an image edge adjustment unit reproduces a pixel row at the edge of the image, to compensate for the number of horizontal pixels.

When a displayed object reaches a limited disparity, a disparity control unit generates a disparity image to implement a proper disparity in subsequent stereoscopic display. Control of the disparity is implemented by optimally setting a camera parameter retroactive to three-dimensional data. A two-dimensional image generation unit calculates a depth Fxy satisfying the proper disparity. When a range of the depth is k1 to k2, and a depth value of each pixel is Gxy, Fxy=J1+(Gxy−K1)×(J2−J1)/(K2−K1). If Fxy is not an integer, processing is performed so that rounding and an approximation disparity are reduced.

### CITATION LIST

### Patent Literature

PTL 1: Japanese Patent Application Laid-Open No. 2004-221699

### SUMMARY OF INVENTION

### Technical Problem

A stereoscopic moving image using a disparity may induce viewer's fatigue when not displayed in an appropriate disparity amount. The appropriate disparity amount changes depending on the size of a display on which the disparity amount is to be displayed and a stereoscopic fusion limit of a viewer. Therefore, for each stereoscopic image frame constituting the stereoscopic moving image, disparity adjustment that matches the stereoscopic image frame needs to be performed.

When a disparity is individually adjusted for each stereoscopic image frame, shift amounts in a disparity direction of right and left images differ for the stereoscopic image frame. FIGS. 16A to 16D schematically illustrate a relationship between left and right images after disparity adjustment and missing portions (portions that are not reflected on the left and right images). FIGS. 16A to 16D respectively illustrate stereoscopic image frames F(1) to F(4) that are continuous in a time series manner. In FIGS. 16A to 16D, a plain rectangular portion indicated by a solid line represents a left-eye image L(i) (i=1 to 4), a plain rectangular portion indicated by a broken line represents a right-eye image R(i) (i=1 to 4), left and right hatched portions of the left-eye image L(i) and the right-eye image R(i) respectively represent missing portions M_{L}(i) (i=1 to 4) and M_{R}(i)=1 to 4). While the left and right images L(i) and R(i) are shifted in a vertical direction to facilitate understanding in FIGS. 16A to 16D, the left and right images are actually shifted in only left and right disparity directions. As illustrated in FIGS. 16A to 16D, the respective missing portions M_{L}(i) and M_{R}(i) at edges of the left-eye image L(i) and the right-eye image R(i) (i=1 to 4) in each of the frames F(i) differ for each stereoscopic image frame, and respective visual fields of the left and right images L(i) and R(i) (ranges in which the images are captured) differ. Thus, an uncomfortable feeling may be given to a viewer of a stereoscopic moving image, to induce eye strain. Thus, respective visual fields of the left and right images L(i) and R(i) (ranges of videos in the missing portions) are preferably matched with each other regardless of the stereoscopic image frame.

PTL 1 discusses only individually processing a still image. In a method discussed in PTL 1, a position of a missing position at an image edge for each stereoscopic image frame may vary. A pixel row at the image edge is only copied so that an uncomfortable feeling is considered to be given to a viewer.

The present invention adjusts a disparity between stereoscopic image frames of a stereoscopic moving image, to prevent a missing position at an edge of the image from varying for each of the stereoscopic image frames.

### Solution to Problems

According to one aspect of the present invention, there is provided an image processing apparatus including a disparity acquisition unit that accepts input of a plurality of stereoscopic image frames constituting a stereoscopic moving image and acquires a disparity in a horizontal direction between left and right viewpoint images constituting each of the stereoscopic image frames, a disparity adjustment unit that adjusts the disparity in the horizontal direction in each of the stereoscopic image frames according to an output condition of the stereoscopic moving image, a reference boundary setting unit that sets left and right reference boundaries that are common among the stereoscopic image frames based on the widths in the horizontal direction of respective ones, satisfying a predetermined reference, of left and right non-output areas respectively serving as areas where image information about the left and right viewpoint images corresponding to each of the stereoscopic image frames in which the disparity has been adjusted by the disparity adjustment unit do not exist at left and right ends of a predetermined output plane, an image processing unit that applies, for left and right complement target areas serving as non-output areas respectively positioned closer to the center of the output plane than the left and right reference boundaries set by the reference boundary setting unit, image information about adjacent areas serving as partial areas within the left and right viewpoint images respectively adjacent to the left and right complement target areas, respectively, to the left and right complement target areas, to complement image information about the left and right complement target areas in each of the stereoscopic image frames, and an output unit that outputs each of the stereoscopic image frames in which the image processing unit has complemented the image information to the left and right complement target areas according to the disparities adjusted by the disparity adjustment unit.

The reference boundary setting unit preferably sets the left and right reference boundaries based on boundaries closer to the center of the left and right non-output areas having the minimum width in the horizontal direction of the output plane.

The reference boundary setting unit preferably sets the left and right reference boundaries based on the boundaries closer to the center of the left and right non-output areas corresponding to the stereoscopic image frame having a disparity adjustment amount of zero in the horizontal direction by the disparity adjustment unit.

The image processing unit preferably deletes the image information about the left and right viewpoint images positioned on the outer side on the output plane than the left and right reference boundaries.

The image processing unit preferably performs first complement processing for copying the image information about the adjacent area to the complement target area, to complement the image information.

The image processing unit preferably performs second complement processing for applying color information about the adjacent area to the complement target area, to complement the image information.

The image processing unit preferably extends the color of the adjacent area to the complement target area according to concentration gradient information about the color of the adjacent area, to complement the image information.

The image processing unit preferably extends straight lines included in the image information about the left and right adjacent areas, respectively, to the left and right complement target areas, to complement the image information.

The image processing unit preferably applies color information for each of partial areas separated by the straight lines in the left and right adjacent areas to each of the partial areas separated by the straight lines extended to the left and right complement target areas, to complement the image information.

The image processing unit preferably determines whether the image information about the adjacent area satisfies a predetermined reference, to perform either one of the first complement processing and the second complement processing based on a result of the determination.

The image processing unit preferably performs the first complement processing when the frequency of a high frequency component in the adjacent area exceeds a predetermined threshold value, and performs the second complement processing when the frequency of the high frequency component in the adjacent area does not exceed the predetermined threshold value.

The image processing unit preferably applies the color information about the left and right adjacent areas to the left and right complement target areas, to complement the image information when the number of pixels composing each of the left and right complement target areas is below a predetermined threshold value.

The reference boundary setting unit preferably sets the left and right reference boundaries based on the boundaries closer to the center of the left and right non-output areas having the minimum width in the horizontal direction of the output plane when the disparity widths defined by the maximum value and the minimum value of the disparity in each of the stereoscopic image frames exceed a predetermined threshold value.

The reference boundary setting unit preferably sets the left and right reference boundaries based on the boundaries closer to the center of the left and right non-output areas corresponding to the stereoscopic image frame having a disparity adjustment amount of zero by the disparity adjustment unit when the disparity widths defined by the maximum value and the minimum value of the disparity in each of the stereoscopic image frames do not exceed the predetermined threshold value.

The image processing unit preferably smoothens the image information in the vicinities of the left and right reference boundaries.

According to one aspect of the present invention, there is provided an image processing method for an image processing apparatus to perform the steps of accepting input of a plurality of stereoscopic image frames constituting a stereoscopic moving image and acquiring a disparity in a horizontal direction between left and right viewpoint images constituting each of the stereoscopic image frames, adjusting the disparity in the horizontal direction in each of the stereoscopic image frames according to an output condition of the stereoscopic moving image, setting left and right reference boundaries that are common among the stereoscopic image frames based on the widths in the horizontal direction of respective ones, satisfying a predetermined reference, of left and right non-output areas respectively serving as areas where image information about the left and right viewpoint images corresponding to each of the stereoscopic image frames in which the disparity has been adjusted do not exist at left and right ends of a predetermined output plane, applying, for left and right complement target areas serving as the non-output areas respectively positioned closer to the center of the output plane than the set left and right reference boundaries, image information about adjacent areas serving as partial areas within the left and right viewpoint images respectively adjacent to the left and right complement target areas, respectively, to the left and right complement target areas, to complement image information about the left and right complement target areas in each of the stereoscopic image frames, and outputting each of the stereoscopic image frames in which the image information has been complemented to the left and right complement target areas according to the adjusted disparities.

According to one aspect of the present invention, there is provided an image processing program for an image processing apparatus to perform the steps of accepting input of a plurality of stereoscopic image frames constituting a stereoscopic moving image and acquiring a disparity in a horizontal direction between left and right viewpoint images constituting each of the stereoscopic image frames, adjusting the disparity in the horizontal direction in each of the stereoscopic image frames according to an output condition of the stereoscopic moving image, setting left and right reference boundaries that are common among the stereoscopic image frames based on the widths in the horizontal direction of respective ones, satisfying a predetermined reference, of left and right non-output areas respectively serving as areas where image information about the left and right viewpoint images corresponding to each of the stereoscopic image frames in which the disparity has been adjusted do not exist at left and right ends of a predetermined output plane, applying, for left and right complement target areas serving as non-output areas respectively positioned closer to the center of the output plane than the set left and right reference boundaries, image information about adjacent areas serving as partial areas within the left and right viewpoint images respectively adjacent to the left and right complement target areas, respectively, to the left and right complement target areas, to complement image information about the left and right complement target areas in each of the stereoscopic image frames, and outputting each of the stereoscopic image frames in which the image information has been complemented to the left and right complement target areas according to the adjusted disparities.

According to one aspect of the present invention, there is provided a computer readable recording medium, in which when a command stored in the recording medium is read and executed by a processor, the processor performs the steps of accepting input of a plurality of stereoscopic image frames constituting a stereoscopic moving image and acquiring a disparity in a horizontal direction between left and right viewpoint images constituting each of the stereoscopic image frames, adjusting the disparity in the horizontal direction in each of the stereoscopic image frames according to an output condition of the stereoscopic moving image, setting left and right reference boundaries that are common among the stereoscopic image frames based on the widths in the horizontal direction of respective ones, satisfying a predetermined reference, of left and right non-output areas respectively serving as areas where image information about the left and right viewpoint images corresponding to each of the stereoscopic image frames in which the disparity has been adjusted do not exist at left and right ends of a predetermined output plane, applying, for left and right complement target areas serving as non-output areas respectively positioned closer to the center of the output plane than the set left and right reference boundaries, image information about adjacent areas serving as partial areas within the left and right viewpoint images respectively adjacent to the left and right complement target areas, respectively, to the left and right complement target areas, to complement image information about the left and right complement target areas in each of the stereoscopic image frames, and outputting each of the stereoscopic image frames in which the image information has been complemented to the left and right complement target areas according to the disparities adjusted by the disparity adjustment unit.

### Advantageous Effects of Invention

According to the present invention, respective areas where no image information exists in stereoscopic image frames are complemented to a common reference boundary by applying, to a complement target area serving as the area where no image information exists inside a reference boundary set in each of the stereoscopic image frames, image information about an adjacent area. Thus, the positions and the sizes of the areas where no image information exists in the stereoscopic image frames are unified so that a user can view a stereoscopic moving image without having an uncomfortable feeling. The complement target area is complemented by applying the image information about the adjacent area. Therefore, there is a little difference in the image information in the vicinity of the reference boundary so that a little uncomfortable feeling is given to the user.

### BRIEF DESCRIPTION OF DRAWINGS

FIG. 1 is a front perspective view of a digital camera.

FIG. 2 is a back perspective view of the digital camera.

FIG. 3A is a block diagram of the digital camera.

FIG. 3B is a block diagram of the digital camera (a continuation).

FIG. 4A is a schematic view of a limit of a disparity in a divergence direction.

FIG. 4B illustrates a relationship between the size of a monitor and a display allowable minimum disparity.

FIG. 5 is a flowchart illustrating disparity adjustment processing.

FIG. 6 illustrates an example of a conversion table between a representative disparity and an output disparity of a stereoscopic moving image.

FIG. 7A is a schematic view of disparity width adjustment.

FIG. 7B is a schematic view of disparity width adjustment.

FIG. 8A is a schematic view of a disparity shift to a negative direction.

FIG. 8B is a schematic view of a disparity shift to a negative direction.

FIG. 9A is a schematic view of a disparity shift after disparity width adjustment.

FIG. 9B is a schematic view of a disparity shift after disparity width adjustment.

FIG. 10A is a schematic view of a disparity shift to a positive direction.

FIG. 10B is a schematic view of a disparity shift to a positive direction.

FIG. 11 is a flowchart illustrating image edge adjustment processing.

FIG. 12 illustrates an example of a non-display area and a complement target area corresponding to each stereoscopic image frame.

FIG. 13 illustrates an example of a straight line and an extension of a color for each of areas separated by the straight line.

FIG. 14 illustrates an example of a reference line set based on a stereoscopic image frame having a disparity adjustment amount of zero.

FIG. 15 is a block diagram of an image processing apparatus.

FIG. 16A illustrates an example of missing portions of left and right images that differ for each stereoscopic image frame, which have resulted from disparity adjustment.

FIG. 16B illustrates an example of missing portions of left and right images that differ for each stereoscopic image frame, which have resulted from disparity adjustment.

FIG. 16C illustrates an example of missing portions of left and right images that differ for each stereoscopic image frame, which have resulted from disparity adjustment.

FIG. 16D illustrates an example of missing portions of left and right images that differ for each stereoscopic image frame, which have resulted from disparity adjustment.

### DESCRIPTION OF EMBODIMENTS

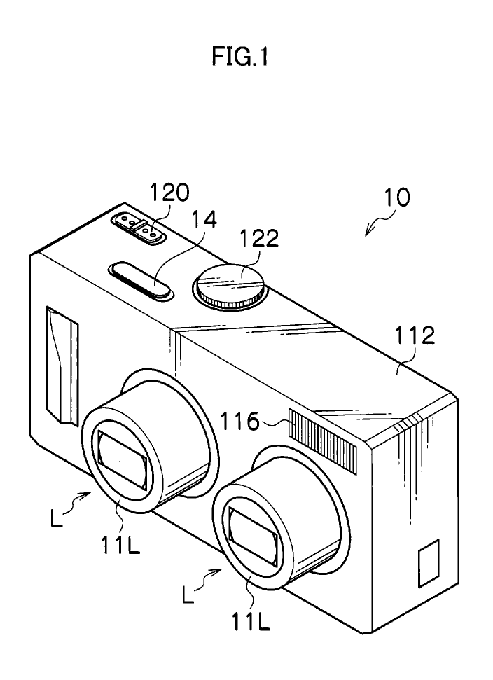

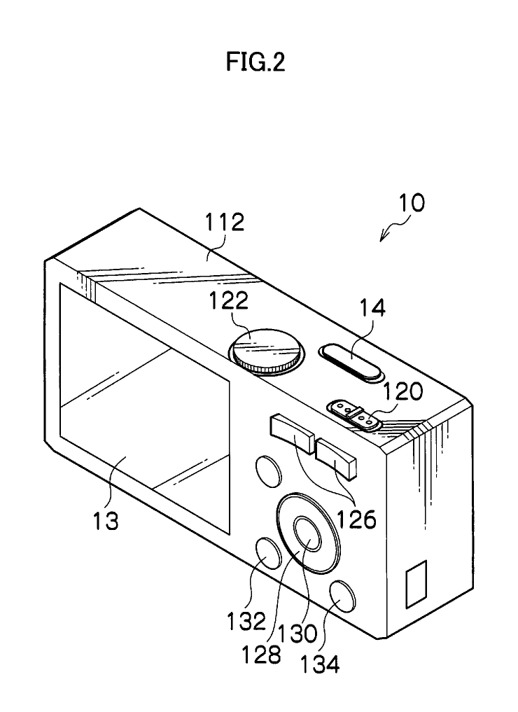

FIG. 1 is a front perspective view illustrating a configuration of the appearance of a digital camera 10 according to an embodiment of the present invention. FIG. 2 is a back perspective view illustrating a configuration of the appearance of an example of the digital camera.

The digital camera 10 includes a plurality of imaging units (two imaging units are illustrated in FIG. 1), and can image the same subject from a plurality of viewpoints (two left and right viewpoints are illustrated in FIG. 1). While a case where the digital camera 10 includes the two imaging units is described as an example for convenience of illustration, the present invention is not limited to this. The present invention is also similarly applicable to a case where the digital camera 10 includes three or more imaging units.

A camera body 112 in the digital camera 10 in this example is formed in a rectangular box shape. A pair of imaging optical systems 11R and 11L and a flash unit 116 are provided, as illustrated in FIG. 1, on a front surface of the camera body 112. A release button 14, a power supply/mode switch 120, a mode dial 122, and others are provided on an upper surface of the camera body 112. A monitor 13 composed of a liquid crystal display (LCD) or the like, a zoom button 126, a cross button 128, a MENU/OK button 130, a DISP button 132, a BACK button 134, and others are provided, as illustrated in FIG. 2, on a back surface of the camera body 112. A monitor 13 may be contained in the digital camera 10, or may be an external device.

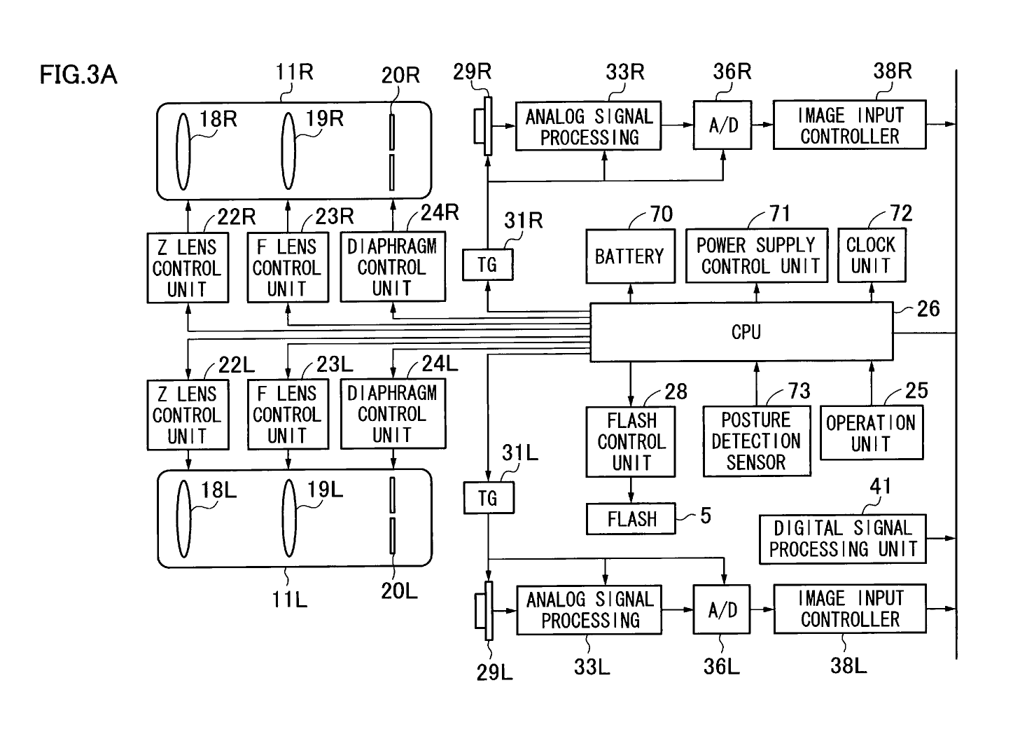

A pair of left and right imaging optical systems 11R and 11L includes retractable zoom lenses (18R and 18L illustrated in FIG. 3), and is delivered from the camera body 112 when power to the digital camera 10 is turned on. Since a zoom mechanism and a retractable lens mechanism in the imaging optical system are a known technique, detailed description thereof is omitted.

A monitor 13 is a display device such as a color liquid crystal panel having a so-called lenticular lens including a semi-cylindrical lens group arranged on its front surface. The monitor 13 is used as an image display unit for displaying an image that has already been captured while being used as a GUI (Graphical User Interface) during various types of setting. During imaging, an image grasped by an image sensor is subjected to through display, and is used as an electronic finder. A system for displaying a stereoscopic image on the monitor 13 is not limited to a parallax barrier system. For example, the display system may be a system for displaying a stereoscopic image using eyeglasses, for example, an anaglyph system, a polarization filer system, or a liquid crystal shutter system.

The release button 14 includes a two-stage stroke-type switch including so-called “half press” and “full press”. The digital camera 10 performs, when a still image is captured (e.g., when a still image capturing mode is selected by a model dial 122 or a menu), imaging preparation processing, i.e., each of AE (Automatic Exposure) processing, AF (Auto Focus) processing, and AWB (Automatic White Balance) processing when the release button 14 is half-pressed and image capturing and recording processing when the release button 14 is full-pressed. When a stereoscopic moving image is captured (e.g., a stereoscopic moving image capturing mode is selected by the mode dial 122 or the menu), the digital camera 10 starts to capture the stereoscopic moving image when the release button 14 is full-pressed and ends the imaging when the release button 14 is full-pressed again. Setting also enables the stereoscopic moving image to be captured while the release button 14 is full-pressed, and enables the imaging to end when the full press of the release button 14 is released. A release button dedicated to capture the still image and a release button dedicated to capture the stereoscopic moving image may be provided.

A power supply/mode switch 120 (a power switch and a mode switch) functions as a power switch for the digital camera 10 while functioning as an operation member for switching a reproduction mode and an imaging mode of the digital camera 10. The mode dial 122 is used to set the imaging mode. The digital camera 10 is set to a 2D still image capturing mode for capturing a 2D still image by setting the mode dial 122 to a “2D sill image position”, and is set to a 3D still image capturing mode for capturing a 3D still image by setting the mode dial 122 to a “3D still image position”. Further, the digital camera 10 is set to a 3D moving image capturing mode for capturing a 3D moving image by setting the mode dial 122 to a “3D moving image position”.

The zoom button 126 is used to perform a zoom operation of the imaging optical systems 11R and 11L, and includes a zoom tele button for issuing an instruction to perform zooming to the telephoto side and a zoom wide button for issuing an instruction to perform zooming to the wide-angle side. The cross button 128 is provided to be able to perform a pressing operation in four directions, i.e., up-and-down and right-and-left directions, and is assigned a function corresponding to a camera setting state for the pressing operation in each of the directions. The MENU/OK button 130 is used to call a menu screen (a MENU function) while being used to confirm a selection content and issue an instruction to perform processing (an OK function). The DISP button 132 is used to input an instruction to switch a display content of the monitor 13, and the BACK button 134 is used to input an instruction to cancel an input operation.

FIGS. 3A and 3B are block diagrams illustrating a principal part of the digital camera 10.

The digital camera 10 includes an imaging unit for a right viewpoint including an imaging optical system 11R and an image sensor 29R for a right viewpoint and an imaging unit for a left viewpoint including an imaging optical system 11L and an image sensor 29L for a left viewpoint.

The two imaging optical systems 11 (11R, 11L) respectively include zoom lenses 18 (18R, 18L), focus lenses 19 (19R, 19L), and diaphragms 20 (20R, 20L). The zoom lenses 18, the focus lenses 19, and the diaphragms 20 are respectively driven by zoom lens control units 22 (22R, 22L), focus lens control units 23 (23R, 23L), and diaphragm control units 24 (24R, 24L). Each of the control units 22, 23, and 24 includes a stepping motor, and is controlled by a drive pulse fed from a motor driver (not illustrated) connected to a CPU (Central Processing Unit) 26.

Behind the two imaging optical systems 11 (11R, 11L), CCD (Charge Coupled Device) image sensors (hereinafter merely referred to as “CCDs”) 29 (29R, 29L) are respectively arranged. The CCD 29 may be replaced with a MOS (metal-oxide semiconductor)-type image sensor. The CCD 29 has a photoelectric conversion surface having a plurality of photoelectric conversion elements arranged therein, as is well known. A subject light beam is incident on the photoelectric conversion surface via the imaging optical system 11 so that a subject image is formed thereon. Timing generators (TGs 31 (31R, 31L)) controlled by the CPU 26 are respectively connected to the CCDs 29. A shutter speed of an electronic shutter (a charge accumulation time of each of the photoelectric conversion elements) is determined in response to a timing signal (a clock pulse) input from the TG 31.

An imaging signal output from the CCD 29 is input to analog signal processing circuits 33 (33R, 33L). The analog signal processing circuit 33 includes a correlation double sampling circuit (CDS), an amplifier (AMP), and others. The CDS generates R, G, and B image data respectively corresponding to charge accumulation times of pixels from the imaging signal. The AMP amplifies the generated image data.

The AMP functions as a sensitivity adjustment unit that adjusts the sensitivity of the CCD 29. ISO (international Organization for Standardization) sensitivity of the CCD 29 is determined by the gain of the AMP. A/D (Analog-to-Digital) converters 36 (36R, 36L) convert the amplified image data from analog image data to digital image data. The digital image data output from the A/D converters 36 (36R, 36L) are temporarily stored as right-viewpoint image data and left-viewpoint image data, respectively, by an SDRAM (Synchronous Dynamic Random Access Memory) 39 serving as a work memory via image input controllers 38 (38R, 38L).

A digital signal processing unit 41 reads out the image data from the SDRAM 39, subjects the image data to various types of image processing such as gradation conversion, white balance correction, γ correction processing, and YC conversion processing, and stores the image data in the SDRAM 39 again. Image data, which has already been subjected to the image processing by the digital signal processing unit 41, is acquired as a through image in a VRAM (Video Random Access Memory) 65, is converted into an analog signal for video output by a display control unit 42, and is displayed on the monitor 13. Image data, which has been subjected to the image processing, acquired as the release button 14 is full-pressed is compressed in a predetermined compression format (e.g., a JPEG (Joint Photographic Experts Group) format) by a compression/decompression processing unit 43, and is then recorded in a memory card 16 as a recording image via a media control unit 15.

An operation unit 25 is used to perform various operations of the digital camera 10, and includes various button switches 120 to 134, illustrated in FIGS. 1 and 2.

The CPU 26 is provided to collectively control the digital camera 10. The CPU 26 controls each of units such as a battery 70, a power supply control unit 71, and a clock unit 72 based on a program and setting information for each of various types of control stored in a flash ROM (Read-Only Memory) 60 and a ROM 61 and an input signal from a posture detection sensor 73 and the operation unit 25.

The digital camera 10 includes an AE/AWB control unit 47 that performs AE (Auto Exposure)/AWB (Auto White Balance) control, and a disparity detection unit 49 that detects a representative disparity in each of a plurality of stereoscopic image frames. The digital camera 10 includes a flash control unit 28 that controls a light emission timing and a light emission amount of a flash 5.

The AE/AWB control unit 47 analyzes an image (captured image) obtained by the CCD 29 when the release button 14 is half-pressed, and calculates a diaphragm value of the diaphragm 20 and a shutter speed of the electronic shutter in the CCD 29 based on luminance information about a subject. The AE/AWB control unit 47 controls the diaphragm value via the diaphragm control unit 24 based on calculation results, and controls the shutter speed via the TG 31.

For example, the respective diaphragm values and shutter speeds of both the imaging optical systems 11R and 11L are calculated based on a captured image (a right viewpoint image or a left viewpoint image) obtained by one of the CCDs 29R and 29L of the two imaging optical systems 11R and 11L. The respective diaphragm values and shutter speeds of the imaging optical systems 11R and 11L may be calculated based on the captured images (the right viewpoint image and the left viewpoint image) respectively obtained by both the imaging optical systems 11R and 11L.

The AF control unit 45 performs AF search control for moving the focus lenses 19R and 19L along an optical axis to calculate a contrast value when the release button 14 is half-pressed, and in-focus control for moving the focus lenses 19R and 19L to an in-focus lens position based on the contrast value. The “contrast value” is calculated based on image signals within predetermined in-focus evaluation value calculation areas of the captured images respectively obtained by the CCDs 29R and 29L. The “in-focus lens position” is respective positions where the focus lenses 19R and 19L are focused on at least a main subject.

For example, the contrast value is calculated in the captured image (the right viewpoint image or the left viewpoint image) obtained by one of the imaging optical systems 11R and 11L while moving at least one of the focus lenses 19R and 19L in the two imaging optical systems 11R and 11L by driving of the motor drivers 27R and 27L. The in-focus lens positions of the focus lenses 19R and 19L in the two imaging optical systems 11R and 11L are respectively determined based on the contrast value, and the motor drivers 27R and 27L are respectively driven, to move the focus lenses 19R and 19L to the respective in-focus lens positions. The in-focus lens positions may be respectively determined in both the imaging optical systems 11R and 11L by performing AF searches.

The posture detection sensor 73 detects a direction in which and an angle at which the imaging optical systems 11R and 11L are rotated relative to a predetermined posture.

A camera shake control unit 62 corrects a shift in the optical axis, which has been detected by the posture detection sensor 73, to prevent a camera shake by driving correction lenses (not illustrated) respectively provided in the imaging optical systems 11R and 11L with a motor.

The CPU 26 controls a face recognition unit 64 so that face recognition is performed from left and right image data respectively corresponding to subject images obtained by the imaging optical systems 11R and 11L. The face recognition unit 64 starts the face recognition according to the control performed by the CPU 26, and performs the face recognition from the left and right image data. The face recognition unit 64 stores face area information including positional information about face areas respectively recognized from the left and right image data in the SDRAM 39. The face recognition unit 64 can recognize the face area from the image stored in the SDRAM 39 by a known method such as a template matching. The face area of the subject includes face areas of a person and an animal in the captured image.

A face correspondence determination unit 66 determines a correspondence relationship between the face area recognized from the right image data and the face area recognized from the left image data. More specifically, the face correspondence determination unit 66 specifies, out of sets of face areas that have been respectively recognized from the left and right image data, the set of face areas about which positional information are closest. The face correspondence determination unit 66 matches image information about the face areas constituting the set, and determines that the face areas constituting the set are in a correspondence relationship when the degree of certainty of identity therebetween exceeds a predetermined threshold value.

The disparity detection unit 49 calculates a representative disparity between predetermined areas of the left and right image data.

For example, the representative disparity is calculated as follows. First, the disparity detection unit 49 calculates a difference in position between corresponding particular points (corresponding points) between the face areas constituting the set. The disparity detection unit 49 calculates an average value of disparities at points included in the face areas constituting the set, and takes the average value as a representative disparity in the set. The disparity detection unit 49 calculates, when a plurality of face areas are determined to have a correspondence relationship, the representative disparity only for main one of the face areas, and stores the representative disparity in the main face area in the SDRAM 39. The main face area includes a face area closest to the center of the screen, a face area closest to the in-focus evaluation value calculation area, and a face area of the largest size.

Alternatively, the disparity detection unit 49 calculates an average value of disparities between corresponding points in predetermined areas in a correspondence relationship between left and right images, e.g., image central areas and in-focus evaluation value calculation areas, and takes the average value as a representative disparity in the set.

Positional information about the predetermined areas in a correspondence relationship and their representative disparities are matched with the left and right image data and stored in the SDRAM 39. For example, positional information about face areas in a correspondence relationship and their representative disparities are stored as collateral information (a header, a tag, meta information, etc.) about the image data. When the image data is compressed and recorded as a recording image in the memory card 16, the positional information about the face areas and the representative disparities are together recorded in the collateral information about the recording image as tag information such as Exif (Exchangeable image file format).

A display allowable disparity width acquisition unit 204 acquires a display allowable minimum disparity Dmin and a display allowable maximum disparity Dmax, and inputs the acquired disparities to a disparity adjustment unit 202. The disparities are acquired in any manner, and may be input from the operation unit 25, may be input from the ROM 61, collateral information about stereoscopic moving image data, or the like, or may be input as control information from the monitor 13.

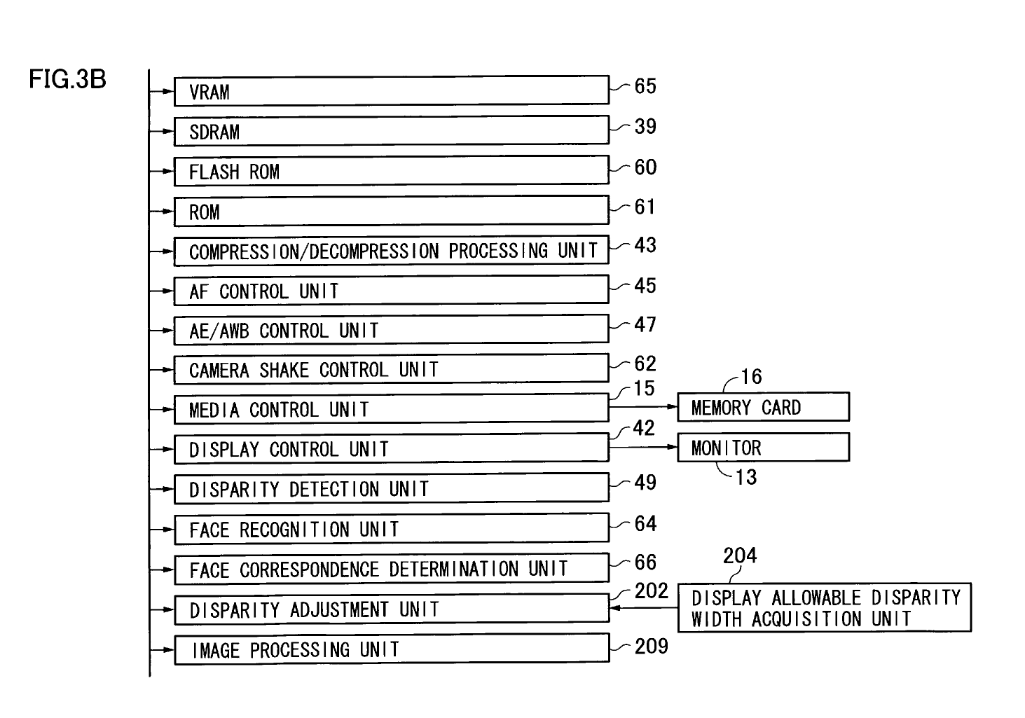

The display allowable maximum disparity Dmax defines a limit of a disparity in a divergence direction (in a direction in which the stereoscopic image on the monitor 13 retreats). As illustrated in FIG. 4A, the eye of a person does not open outward so that left and right images between which there is a disparity exceeding a pupillary distance do not fuse together, and a viewer cannot recognize the left and right images as one image, causing eye strain. When a child viewer is considered, the pupillary distance is approximately 5 cm. Therefore, the number of pixels composing the monitor 13 corresponding to the pupillary distance is the display allowable maximum disparity Dmax. For example, when the monitor 13 is a high-definition television of 16:9 inch size, and the resolution thereof is 1920×1080, the display allowable minimum disparity Dmin for each size of the monitor 13 is as illustrated in FIG. 4B. If the size of the monitor 13 is small, like that of a screen contained in a digital camera or a mobile phone, the disparity in the divergence direction does not easily become a problem. In the case of the monitor 13 having a display surface of large size, like in the television, however, the disparity in a divergence direction becomes a problem.

The display allowable minimum disparity Dmin defines a limit of an excessive disparity (in a direction in which a stereoscopic image on the monitor 13 protrudes). The display allowable minimum disparity Dmin cannot be uniquely determined from the pupillary distance, unlike the display allowable maximum disparity Dmax. For example, an output condition for determining the display allowable minimum disparity Dmin includes (1) the size of the monitor 13, (2) the resolution of the monitor 13, (3) a viewing distance (a distance from the viewer to the monitor 13), and (4) a stereoscopic fusion limit of a viewer individual.

As a standard example, (2) the resolution of the monitor 13 of the high-definition television is 1920×1080, and (3) the viewing distance is three times the height of the screen of the monitor 13. When these are presupposed, (4) the general stereoscopic fusion limit is 57 pixels (a parallactic angle of approximately one degree). Information (1) to (4) may be input from the exterior based on a user's operation and setting information about the monitor 13. For example, the user can input the resolution of the monitor 13 viewed by himself/herself, the viewing distance, and the stereoscopic fusion limit via the operation unit 25. If the information (2) to (4) are not particularly input from the exterior, however, the above-mentioned standard examples are read out of the ROM 61 or the like, and are input to the disparity adjustment unit 202.

The disparity adjustment unit 202 performs disparity adjustment for accommodating a maximum value and a minimum value of the representative disparity of the left and right image data in a display allowable disparity width including a range from the display allowable minimum disparity Dmin to the display allowable maximum disparity Dmax. The disparity adjustment includes shifting each representative disparity in a positive (upper) or negative (lower) direction in a uniform shifting amount and/or reducing each representative disparity at a uniform reduction ratio.

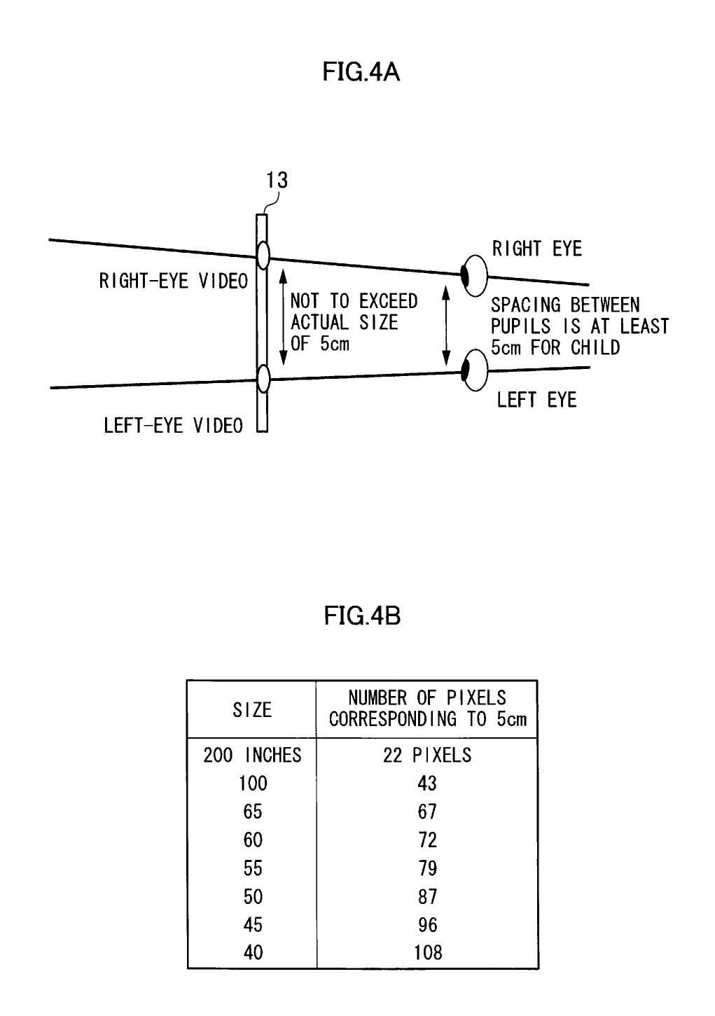

FIG. 5 is a flowchart illustrating disparity adjustment processing. A program for causing each of blocks in the digital camera 10 to perform the processing is stored in a computer readable storage medium such as the ROM 61.

In step S101, the disparity adjustment unit 202 attempts to read out a representative disparity for each of stereoscopic image frames of a stereoscopic moving image stored in the SDRAM 39 or the memory card 16 from left and right image data in the stereoscopic image frame and collateral information about the stereoscopic moving image.

In step S102, the display allowable disparity width acquisition unit 204 acquires a display allowable disparity width in the SDRAM 39. The display allowable disparity width means a range from a display allowable minimum disparity Dmin to a display allowable maximum disparity Dmax. An acquisition source of the display allowable disparity width includes the operation unit 25, the built-in ROM 61, the external monitor 13, an electronic device, and others.

In step S103, the disparity adjustment unit 202 specifies, from the representative disparity in each of the stereoscopic image frames, a maximum value pmax of the representative disparity and a minimum value pmin of the representative disparity, and calculates a stereoscopic disparity width=pmax−pmin. The disparity adjustment unit 202 determines whether the stereoscopic moving image disparity width is less than the display allowable disparity width. If the answer is in the affirmative, the processing proceeds to step S105. If the answer is in the negative, the processing proceeds to step S104.

In step S104, the disparity adjustment unit 202 adjusts the representative disparity in each of the stereoscopic image frames so that the stereoscopic moving imager disparity width falls within the display allowable disparity width.

In step S105, the disparity adjustment unit 202 determines whether the maximum value pmax of the representative disparity is more than the display allowable maximum disparity Dmax. If the answer is in the affirmative, the processing proceeds to step S107. If the answer is in the negative, the processing proceeds to step S106.

In step S106, the disparity adjustment unit 202 determines whether the minimum value pmin of the representative disparity is less than the display allowable minimum disparity Dmin. If the answer is in the affirmative, the processing proceeds to step S107. If the answer is in the negative, the processing proceeds to step S108.

In step S107, the disparity adjustment unit 202 shifts the representative disparity in each of the stereoscopic image frames so that the stereoscopic moving image disparity width falls within the display allowable disparity width.

In step S108, the disparity adjustment unit 202 reads out a representative disparity-output disparity conversion table stored in the ROM 61 or the like to the SDRAM 39. The disparity adjustment unit 202 determines an output disparity corresponding to the representative disparity in each of the stereoscopic image frames according to the representative disparity-output disparity conversion table stored in the ROM 61 or the like.

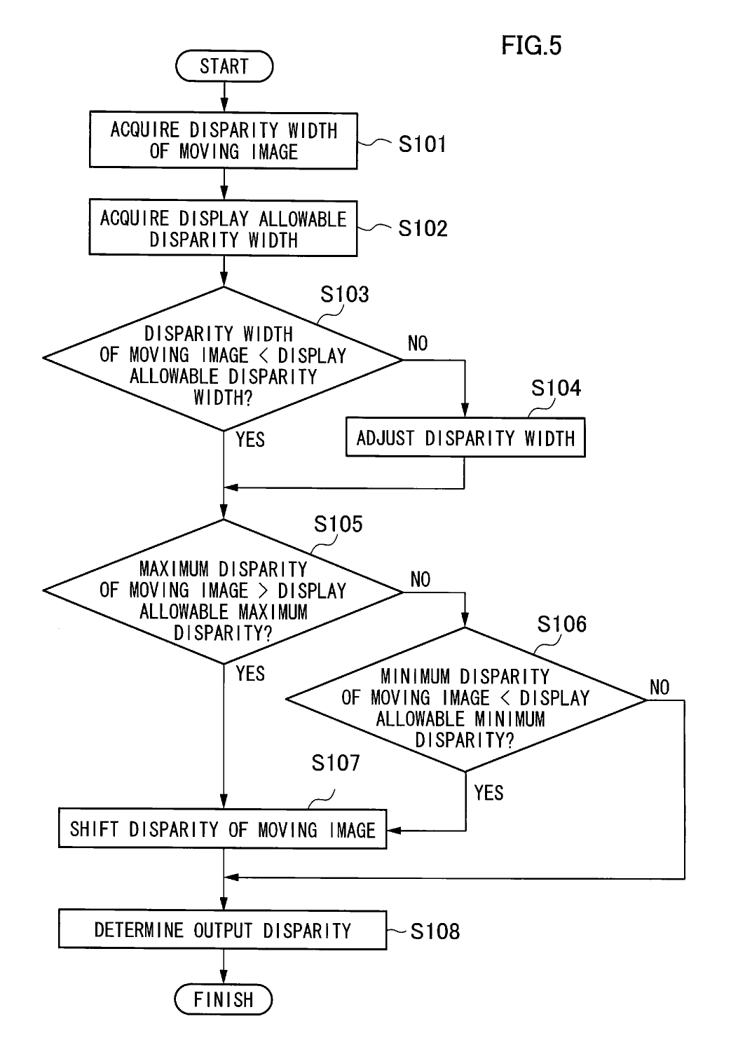

FIG. 6 illustrates an example of the representative disparity-output disparity conversion table. The table illustrated in FIG. 6 defines an integral output disparity corresponding to a representative disparity having any value of each of stereoscopic image frames. For example, according to the table, representative disparities M to M+t correspond to an output disparity N, and representative disparities M to M+2t correspond to an output disparity N+1. Since the minimum display unit of an image is one pixel, an output disparity becomes an integer when represented in units of pixels.

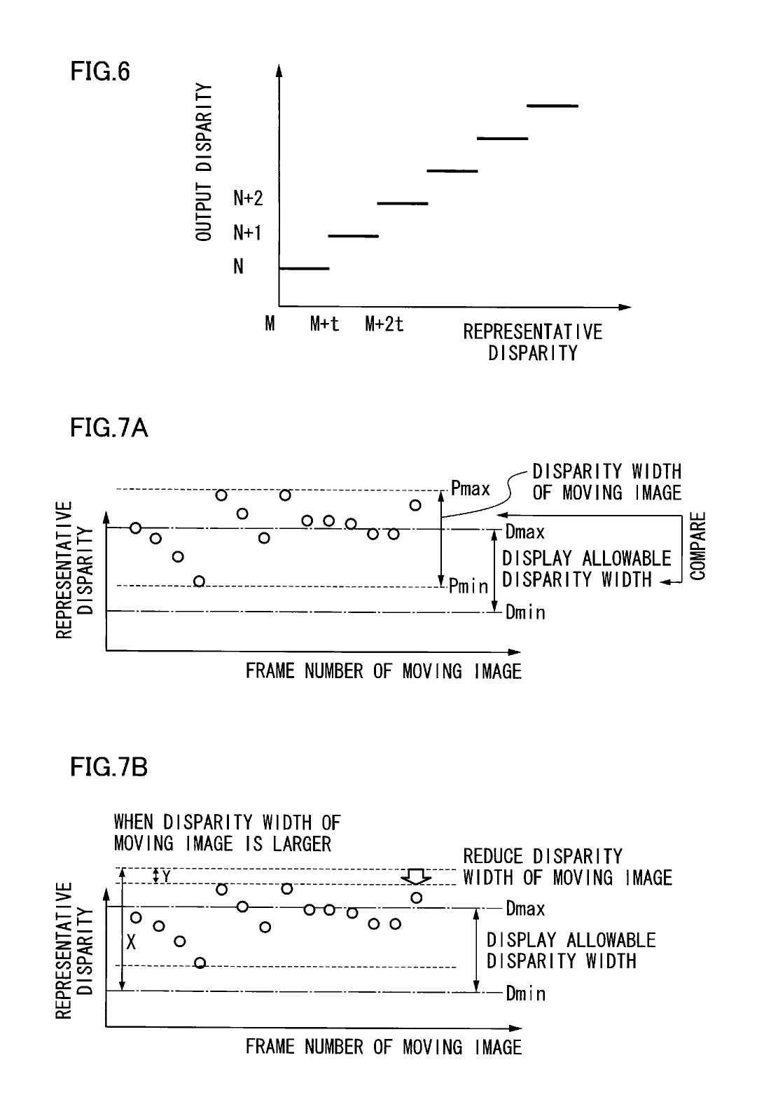

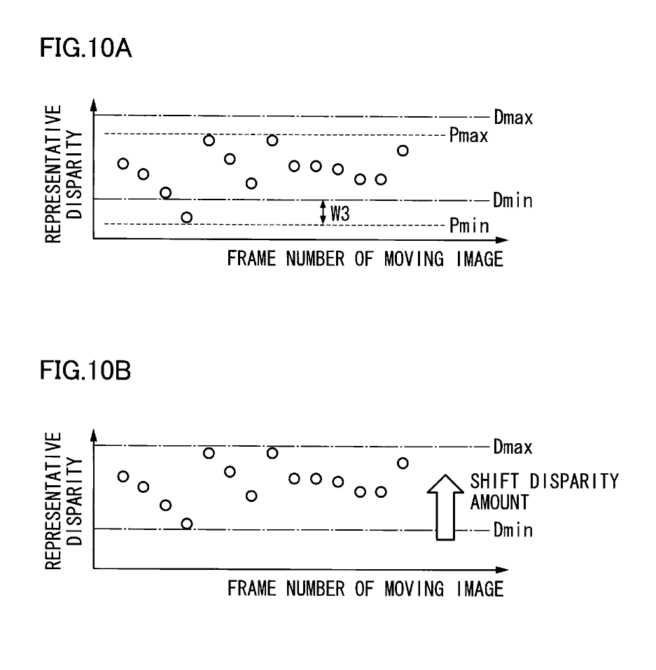

FIGS. 7A and 10B schematically illustrate how disparity adjustment is performed by this processing.

FIGS. 7A to 7B illustrate an example of disparity width adjustment. If a stereoscopic moving image disparity width exceeds a display allowable disparity width, as illustrated in FIG. 7A, a representative disparity in each of stereoscopic image frames is reduced at a uniform reduction ratio (X−Y)/X so that the stereoscopic moving image disparity width falls within a range of the display allowable disparity width, as illustrated in FIG. 7B.

A pattern leading from steps S103 to S107 includes four patterns, i.e., (1) Yes in step S103 and Yes in step S105, (2) No in step S103 and Yes in step S105, (3) Yes in step S103, No in step S105, and Yes in step S106, and (4) No in step S103, No in step S105, and Yes in step S106.

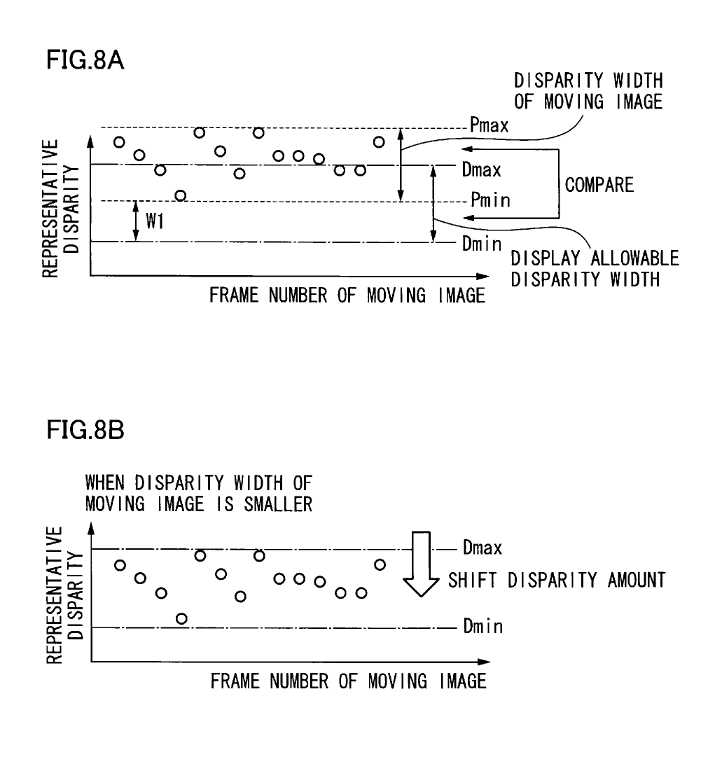

FIGS. 8A and 8B illustrate a shift in a negative direction in the pattern (1), i.e., in a case where disparity width adjustment is not performed.

For example, if the maximum value pmax of the representative disparity in each of the stereoscopic image frames exceeds a display allowable maximum disparity Dmax, but the stereoscopic moving image disparity width is less than the display allowable disparity width, as illustrated in FIG. 8A, the representative disparity is shifted in a negative direction by a uniform width W1, to perform adjustment so that the representative disparities in all the stereoscopic image frames fall within a range of the display allowable disparity width, as illustrated in FIG. 8B. Here, W1=pmin−Dmin.

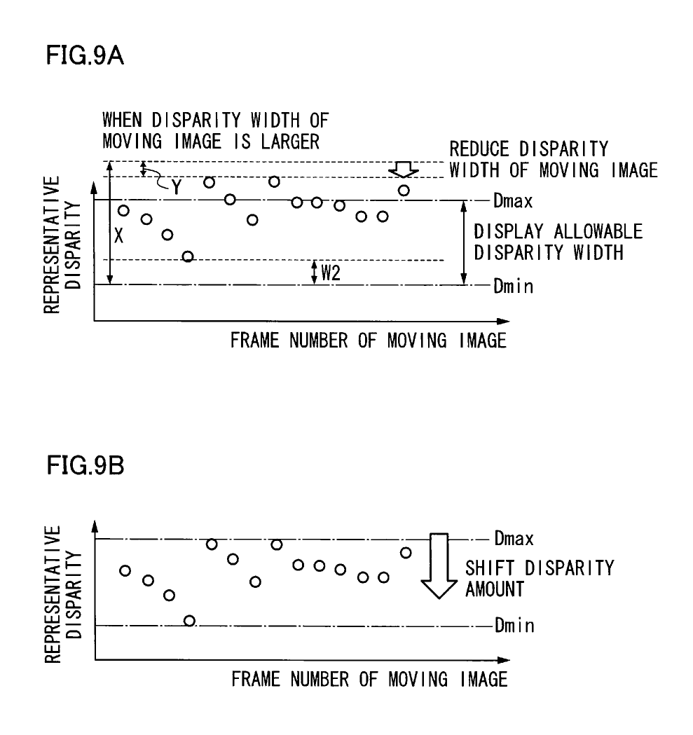

FIGS. 9A and 9B illustrate a shift in a negative direction in the pattern (2), i.e., in a case where disparity width adjustment is performed.

If the maximum value pmax of the representative disparity in each of the stereoscopic image frames after the disparity width adjustment exceeds the display allowable maximum disparity Dmax, as illustrated in FIG. 9A, the representative disparity is shifted in a negative direction by a uniform width W2, as illustrated in FIG. 9B. Here, W2=pmin−Dmin.

FIGS. 10A and 10B illustrate a shift in a positive direction in the pattern (3), i.e., in a case where disparity width adjustment is not performed.

Alternatively, if the minimum value pmin of the representative disparity in each of the stereoscopic image frames is below the display allowable minimum disparity Dmin, as illustrated in FIG. 10A, the representative disparity is shifted in a positive direction by a uniform width W3, as illustrated in FIG. 10B. Here, W2=Dmin−pmin.

If the minimum value pmin of the representative disparity in each of the stereoscopic image frames after the disparity width adjustment is below the display allowable minimum disparity Dmin, although illustration of the pattern (4) is omitted, the representative disparity is similarly shifted in a positive direction by a uniform width.

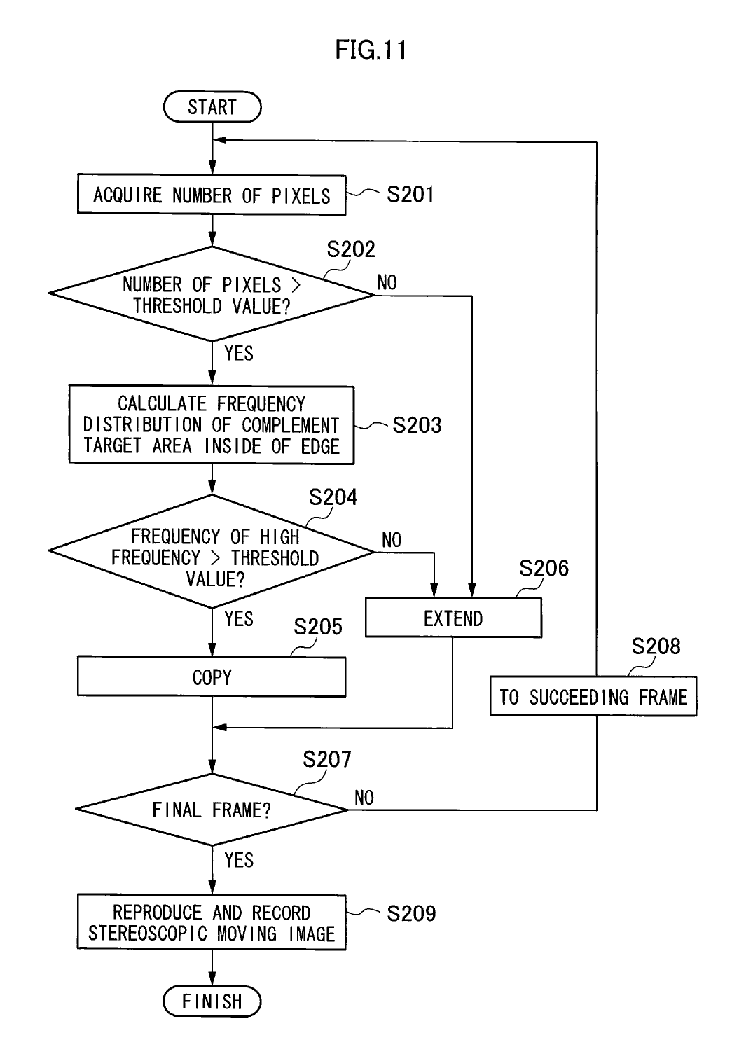

FIG. 11 is a flowchart illustrating image edge adjustment processing. This processing is performed after disparity adjustment processing is completed. A program for causing each of blocks in the digital camera 10 to perform this processing is stored in a computer readable storage medium such as the ROM 61.

In step S201, the image processing unit 209 specifies, out of right non-display areas corresponding to stereoscopic image frames, which occur within a display surface of the monitor 13 as a result of the disparity adjustment processing for each of the stereoscopic image frames, the minimum right non-display area having a minimum horizontal width. The image processing unit 209 specifies, out of left non-display areas corresponding to the stereoscopic image frames, which occur within the display surface of the monitor 13 as a result of the disparity adjustment processing for each of the stereoscopic image frames, the minimum left non-display area having a minimum horizontal width.

A non-display area is an area where respective image information about left and right viewpoint images do not exist within the display surface of the monitor 13. The right non-display area is a non-display area positioned on the right side of the left viewpoint image within the display surface, and the left non-display area is a non-display area positioned on the left side of the right viewpoint image within the display surface.

For example, left non-display areas/right non-display areas respectively corresponding to stereoscopic image frames F1 to F4 are BR1 (L)/BR1 (R) to BR4 (L)/BR4 (R). The horizontal width of the non-display area BR1 (L)/BR1 (R) corresponding to the stereoscopic image frame F1 out of the non-display areas BR1 (L)/BR1 (R) to BR4 (L)/BR4 (R), i.e., the length in a horizontal direction of the display surface of the monitor 13 is the minimum. Accordingly, the image processing unit 209 specifies BR1 (L) as the minimum left non-display area, and specifies BR1 (R) as the minimum right non-display area.

The image processing unit 209 then sets a right edge line LN (L) of the minimum left non-display area and a left edge line LN (R) of the minimum right non-display area, respectively, as a left reference line and a right reference line that are common among the stereoscopic image frames.

Then, the image processing unit 209 specifies, for each of the stereoscopic image frames, a left complement target area serving as a partial area closer to the center of the display surface than the left reference line LN (L) in the non-display area on the left side of the screen. The image processing unit 209 specifies, for each of the stereoscopic image frames, a right complement target area serving as a partial area closer to the center of the display surface than the right reference line LN (R) in the non-display area on the right side of the screen.

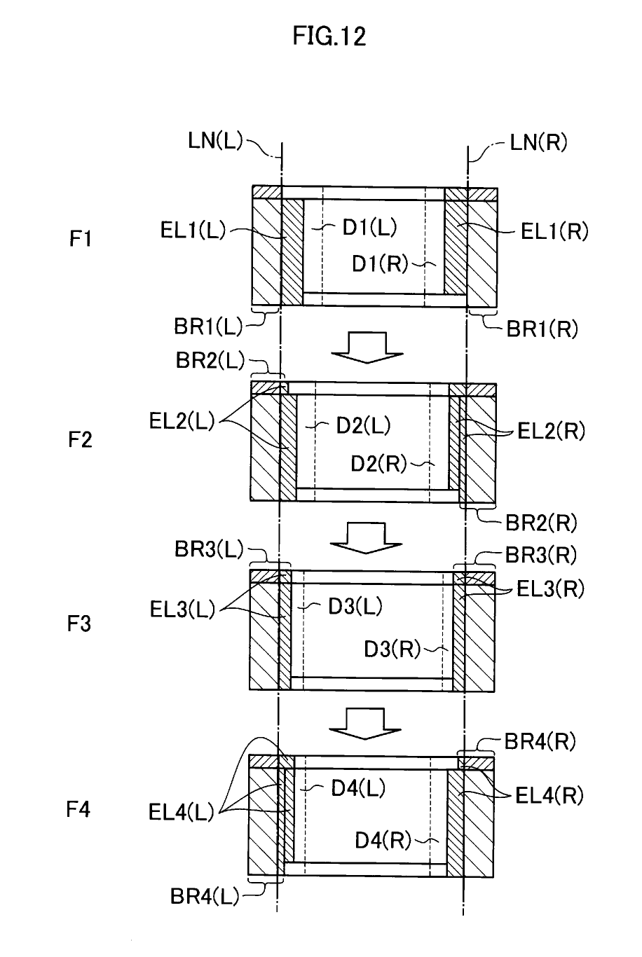

FIG. 12 illustrates left complement target areas EL1 (L) to EL4 (L) and right complement target areas EL1 (R) to EL4 (R) respectively corresponding to the frames F1 to F4.

The image processing unit 209 acquires the number of pixels composing the left complement target area corresponding to a current stereoscopic image frame and the number of pixels composing the right complement target area corresponding thereto.

In step S202, the image processing unit 209 determines whether both the number of pixels composing the left complement target area corresponding to the current stereoscopic image frame and the number of pixels composing the right complement target area corresponding thereto exceed a predetermined threshold value. If the answer is in the affirmative, the processing proceeds to step S203. If the answer is in the negative, the processing proceeds to step S206. When this processing is started, the current stereoscopic image frame is a first stereoscopic image frame of a stereoscopic moving image. The current stereoscopic image frame is switched every time step S208 is repeated after that.

In step S203, the image processing unit 209 calculates, from a left complement reference area serving as one, corresponding to the number of pixels composing the left complement target area, of areas at left edges of left and right viewpoint pixels corresponding to the current stereoscopic image frame, a histogram representing the intensity of each of high and low frequency components.

The image processing unit 209 calculates, from a right complement reference area serving as one, corresponding to the number of pixels composing the right complement target area, of areas at right edges of the left and right viewpoint pixels corresponding to the current stereoscopic image frame, a histogram representing the intensity of each of high and low frequency components.

FIG. 12 illustrates left complement reference areas D1 (L) to D4 (L) and right complement reference areas D1 (T) to D4 (R) respectively corresponding to the frames F1 to F4.

In step S204, the image processing unit 209 determines whether the frequency of the high frequency component in the left complement reference area corresponding to the current stereoscopic image frame exceeds a predetermined threshold value. If the answer is in the affirmative, the processing proceeds to step S205. If the answer is in the negative, the processing proceeds to step S206.

The image processing unit 209 determines whether the frequency of the high frequency component in the right complement reference area corresponding to the current stereoscopic image frame exceeds a predetermined threshold value. If the answer is in the affirmative, the processing proceeds to step S205. If the answer in the negative, the processing proceeds to step S206.

In step S205, the image processing unit 209 copies image information about the left complement target area on the left complement target area if it determines that the frequency of the high frequency component in the left complement reference area corresponding to the current stereoscopic image frame exceeds the predetermined threshold value, to complement the image information about the left complement target area.

Alternatively, the image processing unit 209 copies image information about the right complement target area on the right complement target area if it determines that the frequency of the high frequency component in the right complement reference area corresponding to the current stereoscopic image frame exceeds the predetermined threshold value, to complement the image information about the right complement target area.

This step is processing for directly copying characteristic patterns respectively existing in the left and right complement reference areas on the left and right complement target areas, to make the complement of the image information less noticeable.

In step S206, the image processing unit 209 acquires concentration gradient information and color information from the image information about the left complement reference area if it determines that the frequency of the high frequency component in the left complement reference area corresponding to the current stereoscopic image frame does not exceed the predetermined threshold value. The image processing unit 209 extends the color information from the left complement reference area to the left complement target area according to the concentration gradient information, to complement the image information about the left complement target area.

The image processing unit 209 acquires concentration gradient information and color information from the image information about the right complement reference area if it determines that the frequency of the high frequency component in the right complement reference area corresponding to the current stereoscopic image frame does not exceed the predetermined threshold value. The image processing unit 209 extends the color information from the right complement reference area to the right complement target area according to the concentration gradient information, to complement the image information about the right complement target area.

This step is processing for directly extending gradations respectively existing in the left and right complement reference areas to the complement target areas, to make the complement of the image information less noticeable. Typically, the concentration gradation information is a function for determining the concentration of each color corresponding to a position of a pixel.

In step S208, the image processing unit 209 sets a stereoscopic image frame that is a frame one frame succeeding the current stereoscopic image frame. The current stereoscopic image frames are sequentially selected one at a time out of all the stereoscopic image frames after the disparity adjustment. For example, current stereoscopic image frames respectively corresponding to first to fourth loops of steps S201 to S207 are respectively the stereoscopic image frames F1 to F4 illustrated in FIG. 12.

In step S209, the display control unit 42 sequentially displays the stereoscopic image frames in which the image information have been respectively complemented on the monitor 13 according to the output disparity determined in step S108, to reproduce the stereoscopic moving image.

If the complement is performed in either one of steps S205 and S206, smoothing processing is preferably performed for the image information in the vicinity of the reference lines LN (L) and LN (R), to give a blur to a boundary portion between the original viewpoint image and the complemented image.

From the above-mentioned processing, the image information is uniformly complemented to positions of the reference lines LN (L) and LN (R) in the non-display area occurring outside each of the stereoscopic image frames as a result of the disparity adjustment. As a result of this, all the stereoscopic image frames are of common size, and the size of the non-display area of the image does not vary for each of the stereoscopic image frames so that the stereoscopic moving image is easy to view.

Further, the complement of the image information to the complement target area is performed in either an extension of a gradation and copying of the image information. If the number of pixels composing the complement target area is smaller than a threshold value or the number of characteristic high frequency components is small in the complement reference area, the image information is complemented by the extension of the gradation. If the number of pixels composing the complement area is larger than the threshold value, and the number of characteristic high frequency components is large in the complement reference area, the image information is complemented by the copying to the complement reference area. Thus, the complement target area is prevented from being unnaturally conspicuous.

### Second Embodiment

In step S206 in the first embodiment, if the complement reference area includes a line segment extending toward the complement target area, the line segment is detected, and color information is extended for each of areas separated by the line segment. Thus, a sense of unity between the complement target area and the complement reference area increases, to more effectively prevent the complement target area from being unnaturally conspicuous.

More specifically, an image processing unit 209 detects a straight line from left and right complement reference areas in a current stereoscopic image frame. The straight line can be detected by a known technique. For example, each of the left and right complement reference areas is subjected to differential processing, to extract an edge component of an image, a dot sequence of the extracted edge component is subjected to Hough transform, to generate a histogram according to a function value of the Hough transform, and a peak point of a frequency in the histogram is detected, to extract a straight line component corresponding to the detected peak point and its color from the complement reference areas, as in methods respectively discussed in Japanese Patent Application Laid-Open No. 2008-42800 and Japanese Patent Application No. 6-314339.

The image processing unit 209 selects ones, which reach reference lines LN (L) and LN (R), of the detected straight line components, and determines the selected straight line components, respectively, as straight lines to be extended.

The image processing unit 209 acquires color information for each of areas separated by a pair of straight lines to be extended from within the complement reference areas. The image processing unit 209 then extends the pair of straight lines to be extended to the complement target areas. When the straight lines to be extended are extended, their respective colors are kept the same. The image processing unit 209 copies the color information to the areas separated by the pair of straight lines to be extended after the extension.

Further, the image processing unit 209 may acquire concentration gradient information for each of the separated areas, and assign a gradation to the corresponding separated areas according to the concentration gradation information.

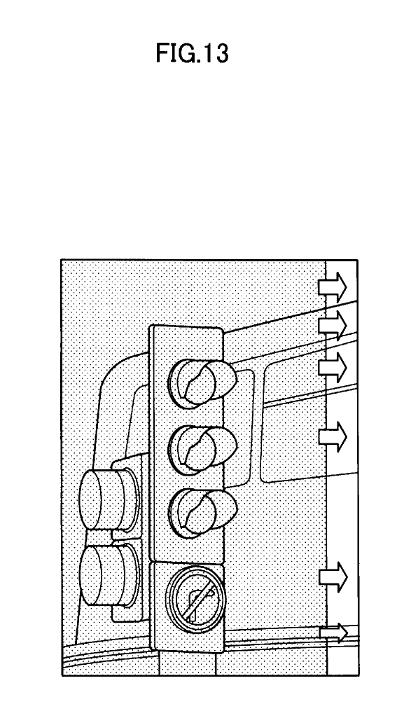

FIG. 13 illustrates an example of an extension of a straight line and a color for each of areas separated thereby. Thus, a line and a color at an edge of an image are extended to an area where the image is not displayed, to prevent an atmosphere of the entire stereoscopic moving image from being destroyed.

### Third Embodiment

In the first exemplary embodiment, the reference lines LN (L) and LN (R) are set to respectively match the non-display areas in the stereoscopic image frame having the largest disparity adjustment amount, and the non-display areas are complemented using the reference lines LN (L) and LN (R) as limits at the ends of the screen in each of the stereoscopic image frames.

Instead, an image processing unit 209 may set reference lines LN (L) and LN (R) to respectively match non-display areas of one, having the smallest disparity adjustment amount, of stereoscopic image frames, and complement the non-display areas with limits of the reference lines LN (L) and LN (R) in each of the stereoscopic image frames.

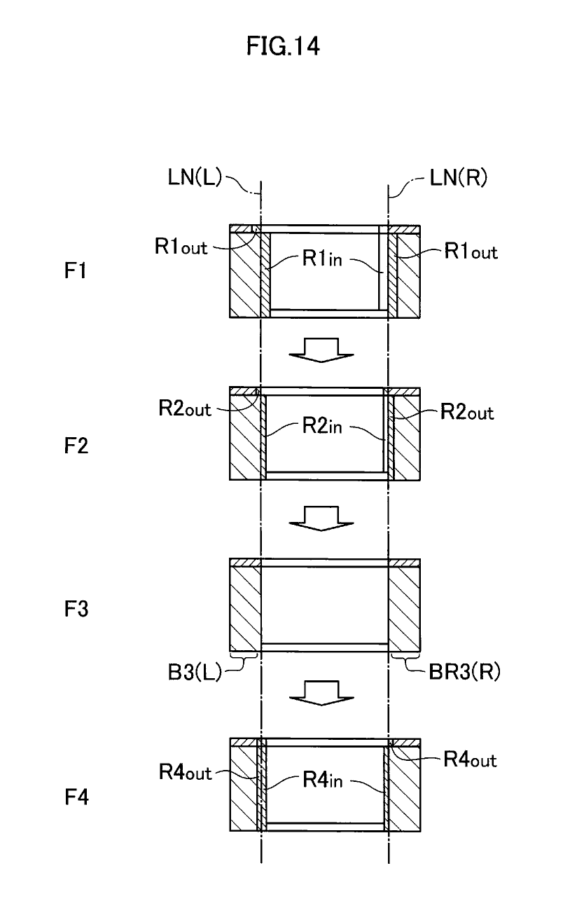

For example, out of stereoscopic image frames F1 to F4, the disparity adjustment amount of the stereoscopic image frame F3 is the smallest, i.e., zero in FIG. 14. The image processing unit 209 sets the reference line LN (L) corresponding to a right end line of a left non-display area in the stereoscopic image frame F3 and the reference line LN (R) corresponding to a left end line of a right non-display area to left and right reference lines that are common among the stereoscopic image frames F1 to F4.

The image processing unit 209 complements the non-display areas existing on the inner side on a screen than the reference lines LN (L) and LN (R) for each of the stereoscopic image frames F1 to F4. For example, an inner area R1in is complemented because it exists on the inner side on the screen than the reference lines LN (L) and LN (R) in the stereoscopic image frame F1. A complement method is similar to that in the first embodiment.

Further, image information about left and right viewpoint images respectively existing on the outer side of the screen than the reference line LN (L) and LN (R) are preferably deleted. The image processing unit 209 deletes partial areas of the left and right viewpoint images existing on the outer side of the screen than the reference lines LN (L) and LN (R) for each of the stereoscopic image frames F1 to F4. For example, an outer area R1out is deleted and taken as a non-display area because it exists on the outer side of the screen than the reference lines LN (L) and LN (R) in the stereoscopic image frame F1.

Similarly, outer areas R2out and R4out and inner areas R2 in and R4 in respectively corresponding to the frames F2 and F4 are also deleted or complemented. The image information is neither complemented nor deleted for the stereoscopic image frame F3 having a disparity adjustment amount of zero.

Further, the image processing unit 209 may switch complement processing in the first embodiment and complement processing in the third embodiment depending on a moving image disparity width.

For example, the image processing unit 209 performs the complement processing in the first embodiment if the moving image disparity width of a certain stereoscopic moving image exceeds a predetermined threshold value. The complement processing in the first embodiment is suited to display an image while preferably keeping its original state because the image is not deleted. Conversely, if a disparity for each stereoscopic image frame greatly varies, a deletion amount of image information increases if the complement processing in the third embodiment is performed. Therefore, the complement processing in the first embodiment is preferable.

On the other hand, the image processing unit 209 performs the complement processing in the third embodiment if the moving image disparity width of the certain stereoscopic moving image does not exceed the predetermined threshold value. If a disparity for each stereoscopic image frame does not greatly vary, a complement target area decreases if the complement processing in the third embodiment is performed. Therefore, the quality of the stereoscopic moving image is kept high, and a processing amount is also small. Further, if the stereoscopic image frame having a disparity adjustment amount of zero is used as a setting basis of the reference lines LN (L) and LN (R), an aspect ratio of each of the stereoscopic image frames after the processing can be kept original.

Whichever method is used to make the complement, a complement target area is not a point of regard so that an impression of the entire stereoscopic moving image is not considered to greatly change by the complement.

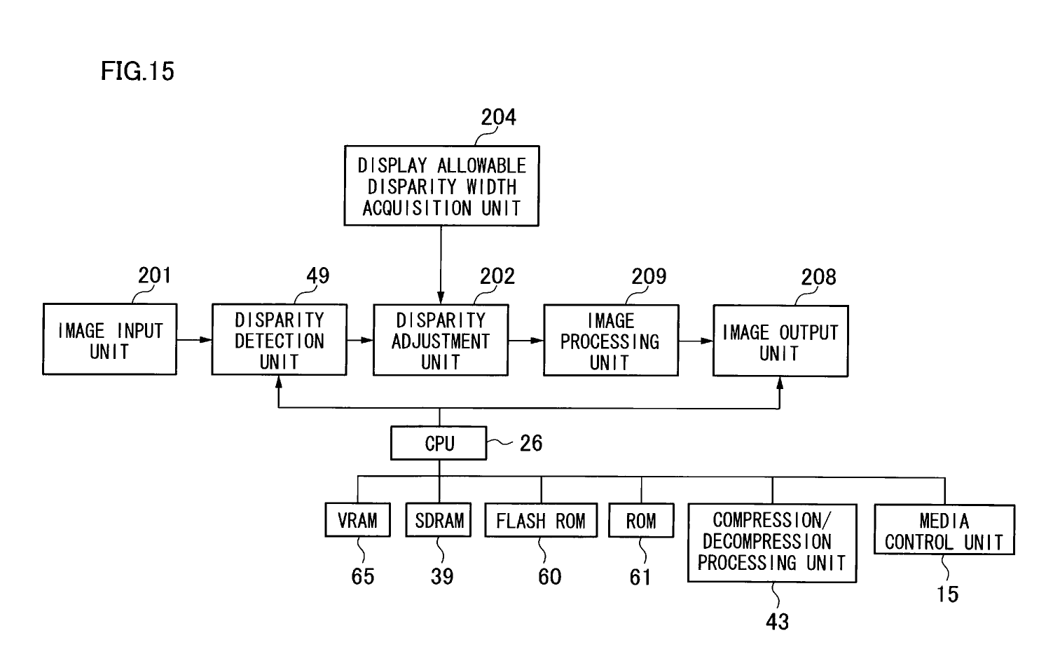

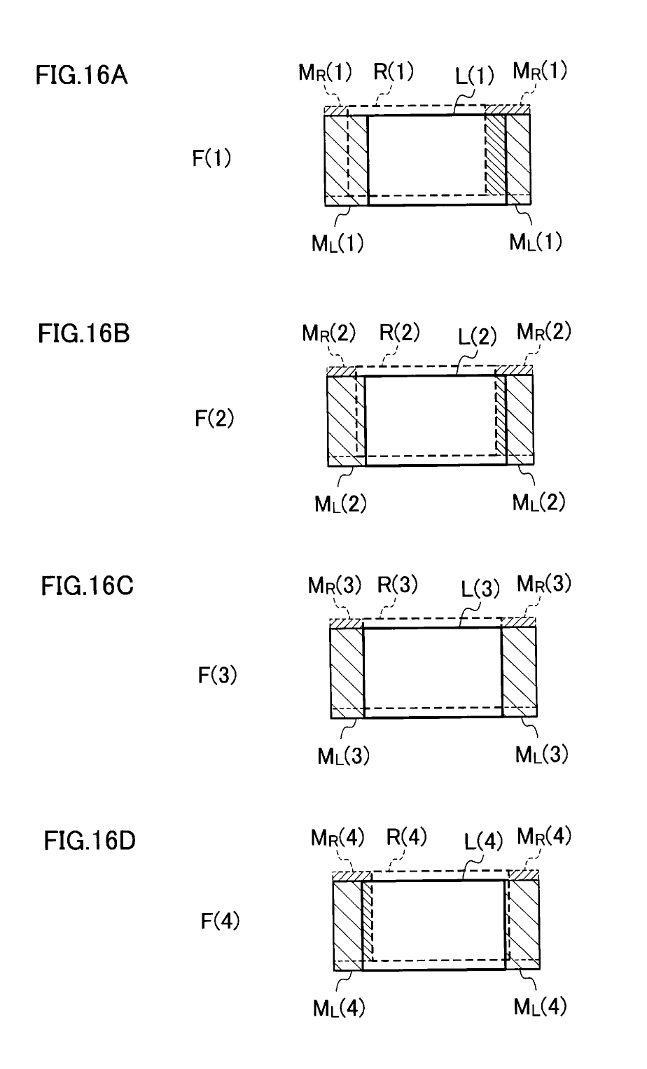

A block required to perform the above-mentioned processing may be provided in an electronic device other than a digital camera. For example, an image processing apparatus including a CPU 26, a VRAM 65, an SDRAM 39, a flash ROM 60, a ROM 61, a compression/decompression processing unit 43, a media control unit 15, a disparity detection unit 49, a disparity adjustment unit 202, an image input unit 201 (e.g., an image input controller 38 and a media control unit 15), a display allowable disparity width acquisition unit 204, an image output unit 208 (e.g., a monitor 13 and the media control unit 15), and an image processing unit 209 can also perform this processing, as illustrated in FIG. 15.

A stereoscopic moving image to be input by the image input unit 201 is not limited to one directly output from imaging means. Examples of the stereoscopic moving image include one read out of a media such as a memory card 16 by the media control unit 15 and one received via a network.

An output destination of an image, which has been subjected to disparity adjustment, by the image output unit 206 is not limited to a display control unit 42 and the monitor 13. The image need not be immediately displayed after the disparity adjustment. For example, the media control unit 15 may record a representative disparity after the adjustment for each of the stereoscopic image frames, i.e., an output disparity on media such as the memory card 16 as stereoscopic moving image data corresponding to the stereoscopic image frame. Alternatively, the stereoscopic moving image data may be sent via a network. Alternatively, each of the stereoscopic image frames may be a print product such as a lenticular print.

A mode setting and a timing as to whether disparity adjustment processing is to be operated may be optional. For example, the disparity adjustment processing is not performed at the start of an imaging mode. However, the disparity adjustment processing is started from the time when a release button 14 is full-pressed. Alternatively, the disparity adjustment processing is started when the stereoscopic moving image data in the memory card 16 is displayed on the external monitor 13 such as a television set.

The image processing apparatus and the image processing method according to each of the above-mentioned embodiments can also be provided as an image processing apparatus having a function of displaying a stereoscopic moving image or a program applicable to the image processing apparatus and a computer readable program for performing the image processing apparatus to perform the above-mentioned processing, and a recording medium storing the program.

### REFERENCE SIGNS LIST

49 . . . disparity detection unit, 202 . . . disparity adjustment unit, 204 . . . display allowable disparity width acquisition unit, and 209 . . . image processing unit

1. An image processing apparatus comprising:
a disparity acquisition unit that accepts input of a plurality of stereoscopic image frames constituting a stereoscopic moving image and acquires a disparity in a horizontal direction between left and right viewpoint images constituting each of the stereoscopic image frames;
a disparity adjustment unit that adjusts the disparity in the horizontal direction in each of the stereoscopic image frames according to an output condition of the stereoscopic moving image;
a reference boundary setting unit that sets left and right reference boundaries that are common among the stereoscopic image frames based on the widths in the horizontal direction of respective ones, satisfying a predetermined reference, of left and right non-output areas respectively serving as areas where image information about the left and right viewpoint images corresponding to each of the stereoscopic image frames in which the disparity has been adjusted by the disparity adjustment unit do not exist at left and right ends of a predetermined output plane;
an image processing unit that applies, for left and right complement target areas serving as non-output areas respectively positioned closer to the center of the output plane than the left and right reference boundaries set by the reference boundary setting unit, image information about adjacent areas serving as partial areas within the left and right viewpoint images respectively adjacent to the left and right complement target areas, respectively, to the left and right complement target areas, to complement image information about the left and right complement target areas in each of the stereoscopic image frames; and
an output unit that outputs each of the stereoscopic image frames in which the image processing unit has complemented the image information to the left and right complement target areas according to the disparities adjusted by the disparity adjustment unit.

2. The image processing apparatus according to claim 1, wherein the reference boundary setting unit sets the left and right reference boundaries based on boundaries closer to the center of the left and right non-output areas having the minimum width in the horizontal direction of the output plane.

3. The image processing apparatus according to claim 1, wherein the reference boundary setting unit sets the left and right reference boundaries based on the boundaries closer to the center of the left and right non-output areas corresponding to the stereoscopic image frame having a disparity adjustment amount of zero in the horizontal direction by the disparity adjustment unit.

4. The image processing apparatus according to claim 3, wherein the image processing unit deletes the image information about the left and right viewpoint images positioned on the outer side on the output plane than the left and right reference boundaries.

5. The image processing apparatus according to claim 1, wherein the image processing unit performs first complement processing for copying the image information about the adjacent area to the complement target area, to complement the image information.

6. The image processing apparatus according to claim 5, wherein the image processing unit performs second complement processing for applying color information about the adjacent area to the complement target area, to complement the image information.

7. The image processing apparatus according to claim 6, wherein the image processing unit extends the color of the adjacent area to the complement target area according to concentration gradient information about the color of the adjacent area, to complement the image information.

8. The image processing apparatus according to claim 7, wherein the image processing unit extends straight lines included in the image information about the left and right adjacent areas, respectively, to the left and right complement target areas, to complement the image information.

9. The image processing apparatus according to claim 8, wherein the image processing unit applies color information for each of partial areas separated by straight lines in the left and right adjacent areas to each of the partial areas separated by straight lines extended to the left and right complement target areas, to complement the image information.

10. The image processing apparatus according to claim 6, wherein the image processing unit determines whether the image information about the adjacent area satisfies a predetermined reference, to perform either one of the first complement processing and the second complement processing based on a result of the determination.

11. The image processing apparatus according to claim 10, wherein the image processing unit performs the first complement processing when the frequency of a high frequency component in the adjacent area exceeds a predetermined threshold value, and performs the second complement processing when the frequency of the high frequency component in the adjacent area does not exceed the predetermined threshold value.

12. The image processing apparatus according to claim 6, wherein the image processing unit applies the color information about the left and right adjacent areas to the left and right complement target areas, to complement the image information when the number of pixels composing each of the left and right complement target areas is below a predetermined threshold value.

13. The image processing apparatus according to claim 2, wherein the reference boundary setting unit sets the left and right reference boundaries based on the boundaries closer to the center of the left and right non-output areas having the minimum width in the horizontal direction of the output plane when the disparity widths defined by the maximum value and the minimum value of the disparity in each of the stereoscopic image frames exceed a predetermined threshold value.

14. The image processing apparatus according to claim 4, wherein the reference boundary setting unit sets the left and right reference boundaries based on the boundaries closer to the center of the left and right non-output areas corresponding to the stereoscopic image frame having a disparity adjustment amount of zero by the disparity adjustment unit when the disparity widths defined by the maximum value and the minimum value of the disparity in each of the stereoscopic image frames do not exceed the predetermined threshold value.

15. The image processing apparatus according to claim 1, wherein the image processing unit smoothens the image information in the vicinities of the left and right reference boundaries.

16. An image processing method for an image processing apparatus to perform the steps of:
accepting input of a plurality of stereoscopic image frames constituting a stereoscopic moving image and acquiring a disparity in a horizontal direction between left and right viewpoint images constituting each of the stereoscopic image frames;
adjusting the disparity in the horizontal direction in each of the stereoscopic image frames according to an output condition of the stereoscopic moving image;
setting left and right reference boundaries that are common among the stereoscopic image frames based on the widths in the horizontal direction of respective ones, satisfying a predetermined reference, of left and right non-output areas respectively serving as areas where image information about the left and right viewpoint images corresponding to each of the stereoscopic image frames in which the disparity has been adjusted do not exist at left and right ends of a predetermined output plane;
applying, for left and right complement target areas serving as the non-output areas respectively positioned closer to the center of the output plane than the set left and right reference boundaries, image information about adjacent areas serving as partial areas within the left and right viewpoint images respectively adjacent to the left and right complement target areas, respectively, to the left and right complement target areas, to complement image information about the left and right complement target areas in each of the stereoscopic image frames; and
outputting each of the stereoscopic image frames in which the image information has been complemented to the left and right complement target areas according to the adjusted disparities.

17. A non-transitory computer-readable medium, wherein when a command stored in the medium is read and executed by a processor, the processor performs the steps of:
accepting input of a plurality of stereoscopic image frames constituting a stereoscopic moving image and acquiring a disparity in a horizontal direction between left and right viewpoint images constituting each of the stereoscopic image frames;
adjusting the disparity in the horizontal direction in each of the stereoscopic image frames according to an output condition of the stereoscopic moving image;
setting left and right reference boundaries that are common among the stereoscopic image frames based on the widths in the horizontal direction of respective ones, satisfying a predetermined reference, of left and right non-output areas respectively serving as areas where image information about the left and right viewpoint images corresponding to each of the stereoscopic image frames in which the disparity has been adjusted do not exist at left and right ends of a predetermined output plane;
applying, for left and right complement target areas serving as non-output areas respectively positioned closer to the center of the output plane than the set left and right reference boundaries, image information about adjacent areas serving as partial areas within the left and right viewpoint images respectively adjacent to the left and right complement target areas, respectively, to the left and right complement target areas, to complement image information about the left and right complement target areas in each of the stereoscopic image frames; and
outputting each of the stereoscopic image frames in which the image information has been complemented to the left and right complement target areas according to the adjusted disparities.
